(19) United States
(12) Patent Application Publication
(10) Pub. No.: US 2024/0403982 A1
(43) Pub. Date: Dec. 5, 2024

(54) CONTRACT DOCUMENT REVIEW PROGRAM, CONTRACT DOCUMENT REVIEW APPARATUS, AND CONTRACT DOCUMENT REVIEW METHOD

(71) Applicant: LegalOn Technologies, Inc., Tokyo (JP)

(72) Inventor: Takahiro MURATA, Tokyo (JP)

(21) Appl. No.: 18/684,474

(22) PCT Filed: Aug. 20, 2021
(86) PCT No.: PCT/JP2021/030550

§ 371 Date: Jul. 24, 2024

(51) Int. Cl. G06Q 50/18; G06F 40/169

(52) U.S. Cl. CPC G06Q 50/18; G06F 40/169

(57) ABSTRACT

The present invention is a contract document review program (10), the contract document review program (10) causing a computer to function as: a contract document reading unit (20) for reading at least document files of a first contract document and a second contract document related to the first contract document, into a computer; a comment generation unit (22) generating comments on articles included in at least the first contract document, based on the document files read by the contract document reading unit; a comment modification unit (24) performing modification including addition, change and/or deletion for the generated comments, based on content of the second contract document; and a comment output unit (32) outputting the comments on the articles of the first contract document generated by the comment generation unit and modified by the comment modification unit.

### TECHNICAL FIELD

The present disclosure relates to a contract document review program, and in particular to a contract document review program for causing a computer to review a contract document. Further, the present disclosure relates to a contract document review apparatus and a contract document review method for reviewing a contract document.

### BACKGROUND

In Japanese Patent Laid-Open No. 2019-114285 (Patent Literature 1), a legal document review program, a legal document review method, and a legal document review system are described. The legal document review system is configured to, when legal document data is inputted, score whether text content included in the legal document data is advantageous for a user or not, using judgment rules. Further, a scoring result is displayed as display content associated with the text content, the display content being shown in a color, size, form or the like that indicates whether the scoring result is advantageous for the user or not.

### CITATION LIST

### Patent Literature

[Patent Literature 1] Japanese Patent Laid-Open No. 2019-114285

### SUMMARY

### Technical Problem

Among legal documents such as contract documents, however, some documents are such that the content is not completed in one document but completed in a plurality of documents. Especially, as for contract documents, there may be a case where the content of one contract is completed by one contract document and another contract document related thereto. For example, a basic contract document and an individual contract document, a (basic) contract document and a changed contract document (including a change memorandum), and the like are examples of such a contract.

The legal document review system described in Patent Literature 1 is a system that scores, for the content of a legal document, whether the content is advantageous for a user or not. Evaluation of the content of one legal document, however, may change due to existence of another legal document related to the one legal document. That is, in the legal document review system according to Patent Literature 1, even if evaluation for the certain content of one legal document is presented, the evaluation may differ from the presented evaluation depending on the content of another legal document related to the one legal document if the other legal document exists.

Therefore, in such a case, it is necessary for a user of the system to review the evaluation presented by the system for the content of the one legal document, in comparison with the content of the other related legal document. Or alternatively, the user has to cause the system to review each of the two related legal documents and perform review, collating evaluation presented for one legal document with evaluation presented for the other legal document. Therefore, in the conventional system, there is a possibility that the user may wrongly evaluate the content of a legal document such as a contract document, or omission in evaluation of the content may occur, and there is a problem that it is not possible to review a contract document with sufficient accuracy.

Therefore, an object of the present invention is to provide a contract document review program capable of, even if there are a plurality of mutually related contract documents, reviewing the contract documents with sufficient accuracy, and a contract document review apparatus.

### Solution to Problem

In order to solve the problem described above, the present invention is a contract document review program for causing a computer to review a contract document, the program causing the computer to function as: a contract document reading unit for reading at least document files of a first contract document and a second contract document related to the first contract document, into a computer; a comment generation unit generating comments on articles included in at least the first contract document, based on the document files read by the contract document reading unit; a comment modification unit performing modification including addition, change and/or deletion for the comments generated by the comment generation unit, based on content of the second contract document; and a comment output unit outputting the comments on the articles of the first contract document generated by the comment generation unit and modified by the comment modification unit.

In the present invention configured as above, the document files of the first and second contract documents are read by the contract document reading unit, and based on these document files, the comments on the articles included in the first contract document are generated by the comment generation unit. Furthermore, the comment modification unit performs modification including addition, change and/or deletion for the generated comments, based on the content of the second contract document, and the modified comments are outputted by the comment output unit.

According to the present invention configured as above, since the comments on the first contract document generated by the comment generation unit are modified by the comment modification unit based on the content of the second contract document, it is possible to, even if there are a plurality of contract documents, review the contract documents with sufficient accuracy.

In the present invention, preferably, the program further causes the computer to function as a preferential contract document setting unit, the preferential contract document setting unit causing a user to set whether the articles included in the first contract document or articles included in the second contract document are to be preferentially applied, the first contract document and the second contract document having been read by the contract document reading unit; and the comment generation unit generates the comments based on the setting by the preferential contract document setting unit, and/or the comment modification unit modifies the comments based on the setting by the preferential contract document setting unit.

According to the present invention configured as above, since a contract document to be prioritized can be set by the preferential contract document setting unit, it is possible to perform more appropriate generation of comments and/or modification of the comments.

In the present invention, preferably, the program further causes the computer to function as an article-of-priority extraction unit, the article-of-priority extraction unit extracting, from the document files of the first contract document and the second contract document, an article of priority stipulating the articles included in which of the first and second contract documents are to be prioritized; and the comment generation unit generates the comments based on content of the article of priority, and/or the comment modification unit modifies the comments based on the content of the article of priority.

According to the present invention configured as above, since the article of priority is extracted by the article-of-priority extraction unit, and the content thereof is considered, it is possible to perform more appropriate generation of comments and/or modification of the comments without missing the article of priority.

In the present invention, preferably, the program further causes the computer to function as an item acquisition unit, the item acquisition unit acquiring standard items from an item database storing items that are to be generally included in a predetermined contract; if there is an omitted item, any item among the standard items that is not written in the first contract document, the comment generation unit generates an omission notification comment to that effect; and, if the omitted item is written in the second contract document, the comment modification unit modifies the omission notification comment.

According to the present invention configured as above, since the item acquisition unit acquires the standard items to be generally included in a predetermined contract, it is possible to prevent omission of items required for a contract. Further, even if there is an item omitted from the first contract document, the omission notification comment is modified if the item is written in the second contract document. Therefore, it is possible to appropriately review omission of an item from a contract that is completed by first and second contract documents.

In the present invention, preferably, any one of the first contract document and the second contract document is a basic contract document, and the other of the first contract document and the second contract document is an individual contract document.

According to the present invention configured as above, since one of the first contract document and the second contract document is the basic contract document, and the other is the individual contract document, it is possible to appropriately review the content of a contract by the basic contract document and the individual contract document that are in a mutually complementary relationship.

Further, the present invention is a contract document review apparatus reviewing a contract document, the contract document review apparatus including: a contract document reading unit for reading at least document files of a first contract document and a second contract document related to the first contract document, into a computer; a comment generation unit generating comments on articles included in at least the first contract document, based on the document files read by the contract document reading unit; a comment modification unit performing modification including addition, change and/or deletion for the comments generated by the comment generation unit, based on content of the second contract document; and a comment output unit outputting the comments on the articles of the first contract document generated by the comment generation unit and modified by the comment modification unit.

Furthermore, the present invention is a contract document review method for reviewing a contract document by a computer, the contract document review method including: a contract document reading process for reading at least document files of a first contract document and a second contract document related to the first contract document, into a computer; a comment generation process for generating comments on articles included in at least the first contract document, based on the document files read by the contract document reading process; a comment modification process for performing modification including addition, change and/or deletion for the comments generated by the comment generation process, based on content of the second contract document; and a comment output process for outputting the comments on the articles of the first contract document generated by the comment generation process and modified by the comment modification process.

### Advantageous Effect of Invention

According to the contract document review program and the contract document review apparatus of the present invention, it is possible to, even if there are a plurality of mutually related contract documents, review the contract documents with sufficient accuracy.

### BRIEF DESCRIPTION OF DRAWINGS

FIG. 1 is a schematic diagram showing an example of an environment where a contract document review program according to an embodiment performs processing.

FIG. 2 is a block diagram showing a configuration example of a server apparatus in which the contract document review program according to the present embodiment operates.

FIG. 3 is a block diagram showing functional units realized in the server apparatus by executing the contract document review program according to the present embodiment.

FIG. 4 is a flowchart showing an overview of a process of the contract document review program according to the embodiment.

FIG. 5 is a diagram showing an example of a screen on a display indicating a state in which document files of contract documents have been uploaded from a terminal in the contract document review program of the embodiment.

FIG. 6 is a diagram showing an example of a review result screen displayed on the display of the terminal by executing the contract document review program of the embodiment, and shows a review result when a contract document has been reviewed alone.

FIG. 7 is a diagram showing an example of the review result screen displayed on the display of the terminal by executing the contract document review program of the embodiment, and shows the review result when the contract document has been reviewed alone.

FIG. 8 is a diagram showing an example of the review result screen displayed on the display of the terminal by executing the contract document review program of the embodiment, and shows the review result when the contract document has been reviewed alone.

FIG. 9 is a diagram showing an example of the review result screen displayed on the display of the terminal by executing the contract document review program of the embodiment, and shows a review result when a plurality of contract documents have been reviewed at the same time.

FIG. 10 is a diagram showing an example of the review result screen displayed on the display of the terminal by executing the contract document review program of the embodiment, and shows the review result when the plurality of contract documents have been reviewed at the same time.

FIG. 11 is a diagram showing an example of the review result screen displayed on the display of the terminal by executing the contract document review program of the embodiment, and shows a review result when the plurality of contract documents have been reviewed at the same time.

FIG. 12 is a diagram showing an example of the review result screen displayed on the display of the terminal by executing the contract document review program of the embodiment, and shows the review result when the plurality of contract documents have been reviewed at the same time.

### EMBODIMENT

A contract document review program according to an embodiment of the present disclosure will be described with reference to the attached drawings.

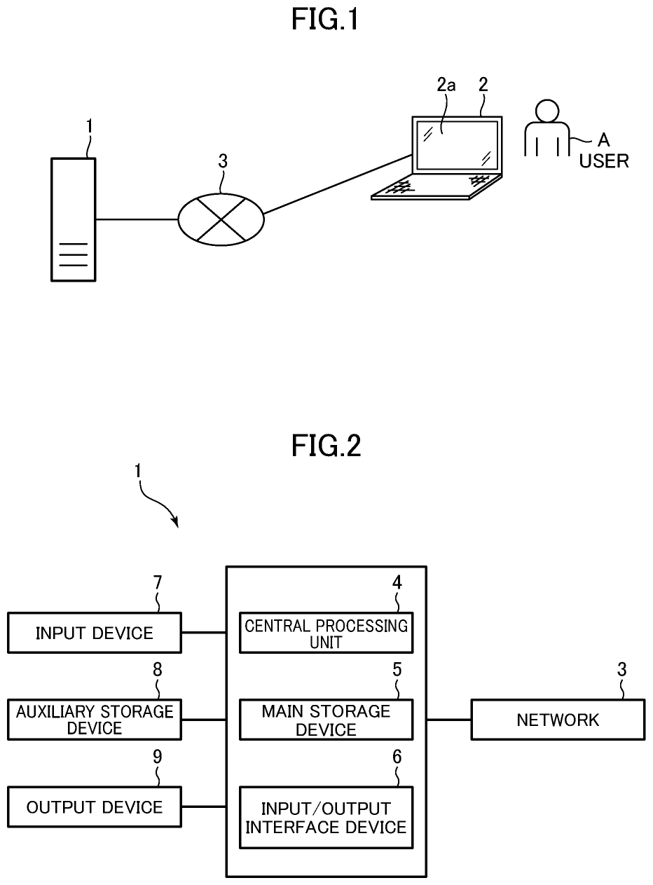

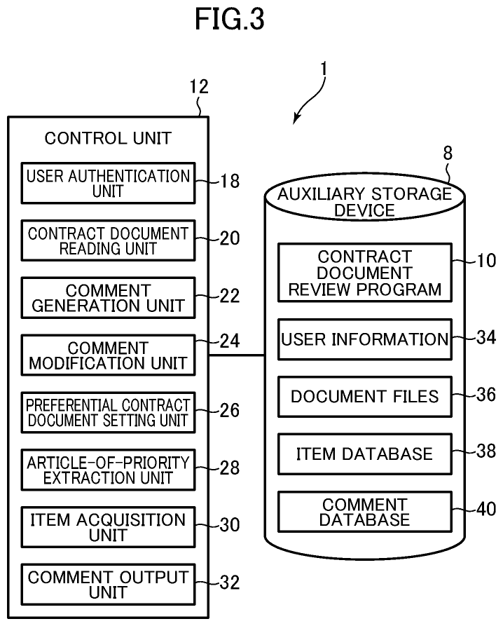

FIG. 1 is a schematic diagram showing an example of an environment where the contract document review program according to the present embodiment performs processing. FIG. 2 is a block diagram showing a configuration example of a server apparatus in which the contract document review program according to the present embodiment operates. FIG. 3 is a block diagram showing functional units realized in the server apparatus by executing the contract document review program according to the present embodiment.

The contract document review program according to the present embodiment may operate in an environment where a server apparatus 1, which is a computer, and a terminal 2 may be mutually communicably connected via a network 3 as shown in FIG. 1. Here, the terminal 2 may be operated by a user A who uses review of contract documents.

The server apparatus 1 may be a server-type information processing apparatus, which operates in response to a request of the terminal 2, and is provided with an electronic circuit configured with electronic parts, such as a CPU (central processing unit) having functions for processing information and a flash memory, in its body. The server apparatus 1 may be configured with a single information processing apparatus and may be such that a plurality of information processing apparatuses operate in cooperation or such that is operated by any cloud service.

The terminal 2 may be an information processing apparatus such as a PC (personal computer) or a tablet terminal and may be provided with electronic parts, such as a CPU having functions for processing information and a flash memory, in its body.

The network 3 may be a communication network enabling high-speed communication, and a wired or wireless communication network, for example, the Internet, an intranet, or a LAN (local area network) for which security measures are taken can be used as the network.

In the above environment, the server apparatus 1 in which the contract document review program according to the present embodiment is installed may execute review of contract documents based on an operation by the user A. By the user A making operations from the terminal 2 after uploading document files of a first contract document and a second contract document related thereto to the server apparatus 1 from the terminal 2, review of the first and second contract documents may be executed.

The document files of the first and second contract documents may be uploaded from the single terminal 2 and each may be uploaded from different terminals. Further, the number of contract documents to be reviewed may be two, and the present embodiment may be configured to execute review of one, three, or more contract documents.

Next, a detailed configuration of the server apparatus 1 will be described. As shown in FIG. 2, the server apparatus 1 may include a central processing unit 4, which is a processor, a main storage device 5, an input/output interface device 6, an input device 7, an auxiliary storage device 8, and an output device 9. These devices may be mutually connected via a data bus and/or a control bus. The auxiliary storage device 8 may be configured with a storage medium such as a hard disk device or a flash memory and is configured to store information. A contract document review program 10 of the present embodiment may be stored in the auxiliary storage device 8, and may execute review of contract documents by being read into the main storage device 5 when being executed.

In such a hardware configuration, the central processing unit 4 may sequentially load instructions and data related to a particular application (a computer program) stored in the auxiliary storage device 8 to the main storage device 5 and may perform operation of the loaded instructions and data. Thereby, the central processing unit 4 may control the output device 9 via the input/output interface device 6 or may perform transmission/reception of various information (data) to/from other apparatuses (for example, the terminal 2) via the input/output interface device 6 and the network 3.

Thereby, the server apparatus 1 may execute the installed particular application to function as a web server. Thereby, the server apparatus 1 may execute various operations about review of contract documents, which are to be described later, via a web page transmitted to the terminal 2 (furthermore, the computer program incorporated in the web page and executed by the terminal 2). Or alternatively, the server apparatus 1 may execute the installed particular application to function as an application server. Thereby, the server apparatus 1 may execute similar operations.

Next, each of functional units realized on the server apparatus 1 by executing the contract document review program 10 of the present embodiment will be described with reference to FIG. 3. The server apparatus 1 may operate as a control unit 12 by executing the contract document review program 10 of the present embodiment, and functions of a user authentication unit 18, a contract document reading unit 20, a comment generation unit 22, a comment modification unit 24, a preferential contract document setting unit 26, an article-of-priority extraction unit 28, an item acquisition unit 30, a comment output unit 32, and the like may be realized.

When receiving an authentication request together with information such as a user ID and a password from the terminal 2, the user authentication unit 18 may refer to user information 34 including user IDs, passwords, and the like, which is registered in advance and stored in the auxiliary storage device 8, to perform user authentication.

The contract document reading unit 20 may accept document files 36 of contract documents from the terminal 2 operated by the user A and may store the document files 36 into the auxiliary storage device 8. For example, the contract document reading unit 20 may operate so as to read document files of the first contract document and the second contract document related thereto, into the server apparatus 1. As described above, the contract document reading unit 20 may accept the document files 36 from a plurality of terminals.

The present embodiment may also be configured to perform anonymization processing when accepting the document files 36 of the contract documents read by the contract document reading unit 20 and storing the document files 36 into the auxiliary storage device 8. That is, in the anonymization processing, names of parties to the contract written in the contract documents may be replaced with predetermined character strings or the like to anonymize the contracting parties and the like. Specifically, by extracting proper nouns of the contracting parties and the like included in the document files 36 and replacing character strings indicating the extracted proper nouns with particular character strings, the contracting parties may be anonymized. It is preferable to anonymize, in addition to the contracting parties, a particular product name, service name, project name, and the like. Thereby, it is possible to minimize the risk of leakage of confidential information due to the contract documents being uploaded to the server apparatus 1.

The comment generation unit 22 may generate comments on articles included in the contract documents based on the document files read by the contract document reading unit 20. In the present embodiment, the comment generation unit 22 may generate the comments on each of the plurality of contract documents read by the contract document reading unit 20. The comment generation unit 22 may, however, generate the comments on at least one contract document among the document files read as the contract documents.

As the comments generated by the comment generation unit 22, for example, the following can be exemplified: (1) indications about whether articles included in each contract document are advantageous or disadvantageous for the user A, and results of scoring the articles; (2) advice on modification and deletion of articles included in the contract document; (3) indications about omission of items that should be generally included in the contract document, and proposal of items to be added; and the like.

Here, the comment generation unit 22 may first analyze the content of the contract documents from the read document files of contract documents and may extract information showing the state of the contract. A method for extracting the information from the content of the contract documents may be such that information corresponding to keywords specified in advance, characters, figures, and the like included near the keywords are extracted, such that morphological, parsing, semantic, and contextual analyses are performed to perform the extraction, or such that labeling based on machine learning is performed to perform the extraction.

Next, the comment generation unit 22 may apply conditional rules set in advance to the extracted information and may select example sentences of comments suitable for the extracted contract information. The example sentences of comments suitable for pieces of contract information may be stored in the auxiliary storage device 8 as a comment database 40, and the comment generation unit 22 may select, from the comment database 40, the most appropriate comments that meet conditions. For application of the extracted information to the conditional rules, a processing method such as natural language processing can be appropriately used. Furthermore, the comment generation unit 22 may generate comments by modifying the selected example comment sentences according to the text of the contract documents that are being analyzed.

The comment modification unit 24 may perform modification including addition, change, and/or deletion, for the comments generated by the comment generation unit 22. When the comment generation unit 22 generates comments on the first contract document, the comment modification unit 24 may modify the comments on the first contract document based on the content of the second contract document related to the first contract document. Further, when three or more document files of contract documents are read, the comment modification unit 24 may modify comments based on the content of contract documents other than a contract document for which the comments have been generated by the comment generation unit 22. In the present specification, “modification” may be assumed to include addition, change, and/or deletion of comments.

The preferential contract document setting unit 26 may cause the user A to set whether articles included in the first contract document or the articles included in the second contract document are to be preferentially applied, the first contract document and the second contract document having been read by the contract document reading unit 20. The present embodiment may also be configured so that, when three or more contract documents are read, the user may set priority order of the contract documents.

The preferential contract document setting unit 26 may be configured so that the user A can set the articles written in which contract document, among the contract documents read by the contract document reading unit 20, are preferentially applied over articles written in the other contract documents. For example, when the first contract document and the second contract document have been read by the contract document reading unit 20, the user A may operate the terminal 2 to specify a contract document to be prioritized between the first and second contract documents, on a display 2a of the terminal 2. The comment generation unit 22 may generate comments based on the setting by the preferential contract document setting unit 26. Further, the comment modification unit 24 may modify the comments based on the setting by the preferential contract document setting unit 26.

The article-of-priority extraction unit 28 may extract an article of priority stipulating the articles included in which of the contract documents are to be prioritized, from the document files of contract documents read by the contract document reading unit 20. For example, when the document files of the first contract document and the second contract document have been read, the article-of-priority extraction unit 28 may extract the article of priority stipulating the articles included in which of the contract documents are to be prioritized. The comment generation unit 22 can generate comments based on the content of the article of priority extracted by the article-of-priority extraction unit 28. Furthermore, the comment modification unit 24 can modify the comments based on the content of the article of priority.

Any one of the preferential contract document setting unit 26 and article-of-priority extraction unit 28 described above can be omitted. Furthermore, when the article-of-priority extraction unit 28 is provided, the present embodiment may also be configured so that a contract document to be preferentially applied is automatically selected based on the article of priority extracted by the article-of-priority extraction unit 28. Further, when both of the preferential contract document setting unit 26 and the article-of-priority extraction unit 28 are provided, the present embodiment can also be configured so that, if a contract document is not selected by the preferential contract document setting unit 26, a contract document to be preferentially applied may be automatically selected. Or alternatively, the present embodiment can be configured so that “automatic selection” can be set by the preferential contract document setting unit 26. If the “automatic selection” is set, a contract document to be preferentially applied may be set based on the article of priority extracted by the article-of-priority extraction unit 28.

An item database 38 may be stored in the auxiliary storage device 8. In the item database 38, items to be generally included in a predetermined contract may be listed up. For example, as the items included in the item database 38, standard items for a worker dispatch contract, which are listed up as standard items to be generally included in a worker dispatch contract, standard items for a sales contract, and standard items for a lease contract may be exemplified.

According to the contract documents read by the contract document reading unit 20, the item acquisition unit 30 of the control unit 12 may acquire standard items which are items to be generally included in the contract documents, from the item database 38. If there is an omitted item, any item among the standard items that is not written in the first contract document acquired by the item acquisition unit 30, the comment generation unit 22 may generate an omission notification comment to that effect. Further, if the omitted item is written in the second contract document, the comment modification unit 24 may modify the omission notification comment generated by the comment generation unit 22.

The comment output unit 32 may output, to the terminal 2, the comments on the articles of the contract documents generated by the comment generation unit 22 and modified by the comment modification unit 24. That is, the comment output unit 32 may output the comments on the reviewed contract documents from the input/output interface device 6 to the terminal 2 to display the comments on the display 2a of the terminal 2. In the present embodiment, the articles of the reviewed contract documents may be displayed on the display 2a of the terminal 2, and the comments may be displayed in a comment field adjacent to the displayed articles.

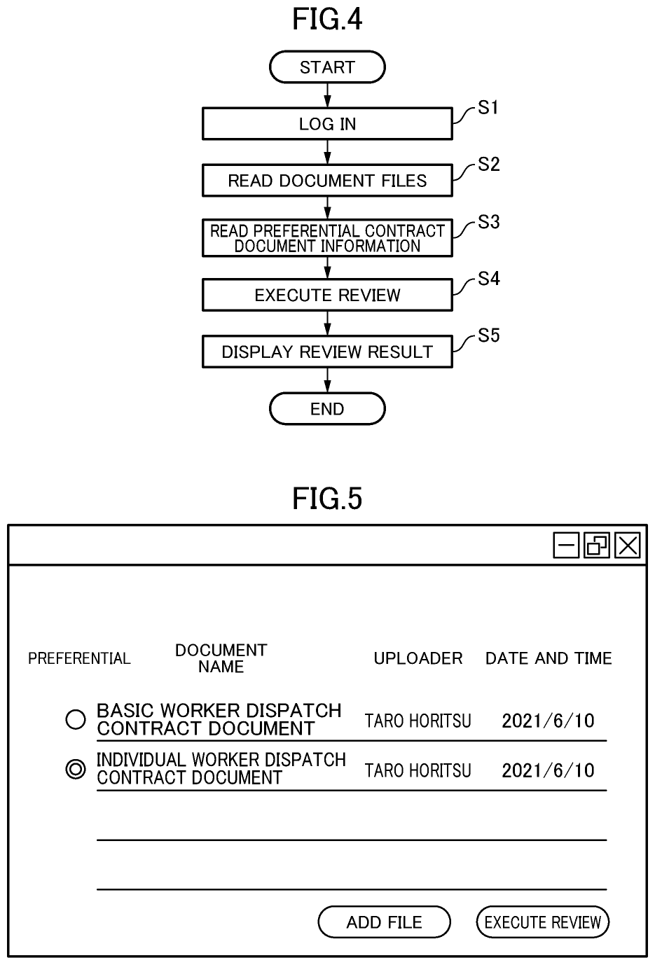

Next, operation of the contract document review program according to the embodiment of the present embodiment will be described with reference to FIGS. 4 to 12.

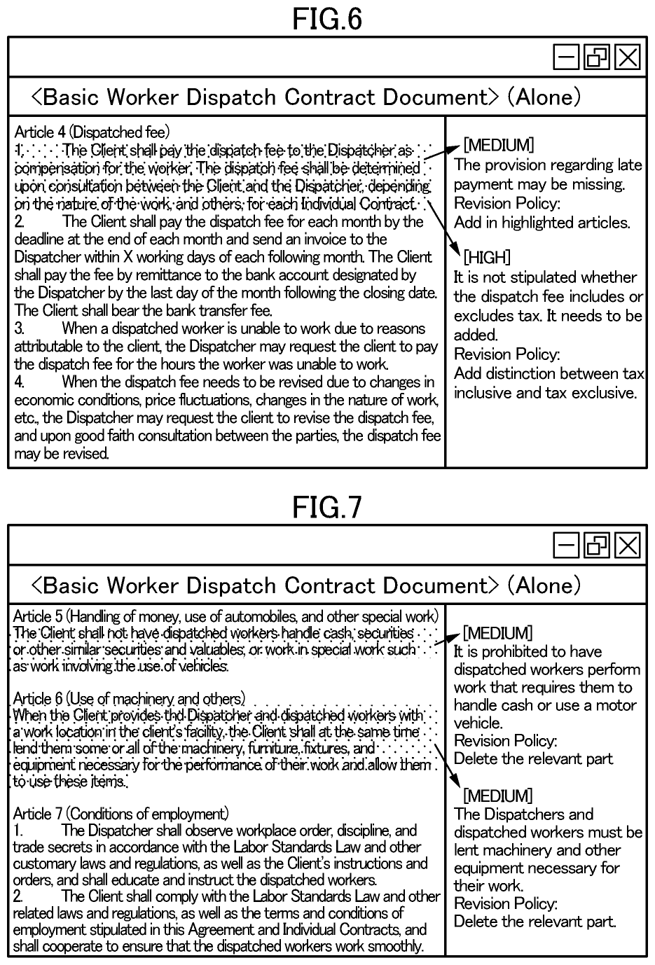

FIG. 4 is a flowchart showing an overview of a process of the contract document review program according to the present embodiment. FIG. 5 is a diagram showing an example of a screen on the display 2a indicating a state in which document files of contract documents have been uploaded from the terminal 2. FIGS. 6 to 12 are diagrams showing examples of a review result screen displayed on the display 2a of the terminal 2 by executing the contract document review program of the present embodiment.

First, at step S1 of FIG. 4, the server apparatus 1 may receive a request to log in a service, which has been sent by the user A operating the terminal 2. When information such as the user ID and the password is inputted by the user A, the terminal 2 may transmit an authentication request to the server apparatus 1 together with the information, and the server apparatus 1 receives them.

When receiving the authentication request together with the information such as the user ID and the password from the terminal 2, the user authentication unit 18 of the server apparatus 1 may refer to the user information 34 including the user IDs, the passwords, and the like which have been registered in advance, to perform authentication of the user A.

When login into the service is completed, document files of contract documents for which review is to be executed may be uploaded by an operation of the terminal 2 by the user A, and the server apparatus 1 may read the document files at step S2, as a contract document reading process. That is, as shown in FIG. 5, the user A may click an “Add File” button on the display 2a of the terminal 2 to select the document files of the contract documents stored in a storage device included in the terminal 2. The terminal 2 may upload the document files selected by the user A to the server apparatus 1. Further, at step S2, the server apparatus 1 may also receive the types of the uploaded contract documents and the position of the user A in the contract documents, which have been inputted by the user A via the terminal 2.

Here, in the contract document review program 10 of the present embodiment, it may review a plurality of mutually related contract documents, and comments may presented for articles of one contract document in consideration of articles written in the other contract documents. The contract document reading unit 20 of the server apparatus 1 may accept the document files 36 from the terminal 2 by an operation by the user A and may store the document files 36 into the auxiliary storage device 8.

Further, as shown in FIG. 5, the contract document reading unit 20 may display a list of the document files 36 accepted from the terminal 2 on the display 2a of the terminal 2. In the example shown in FIG. 5, a document file of “Basic Worker Dispatch Contract Document” and a document file of “Individual Worker Dispatch Contract Document” have been uploaded and displayed on the display 2a.

Next, at step S3 of FIG. 4, the server apparatus 1 may receive information about a contract document to be preferentially applied between the uploaded document files. That is, the user may select the articles written in which contract document are to be preferentially applied, from among the document files 36 of the contract documents displayed on the display 2a of the terminal 2. The preferential contract document setting unit 26 of the server apparatus 1 may display “◯ (white circle)” at the top of the document file name of each contract document displayed on the display 2a of the terminal 2. By the user A clicking “◯” attached to the document file of the contract document to be prioritized, the displayed “◯” may change to “⊚ (double circle)”, and the contract document to be prioritized is set. Information about it may be inputted to the server apparatus 1. In the example shown in FIG. 5, “Individual Worker Dispatch Contract Document” is selected as the contract document to be preferentially applied, and a symbol on the left side of the document name has changed to “⊚.”

Next, at step S4 of FIG. 4, the server apparatus 1 may generate comments based on an operation of the terminal 2 by the user A. That is, when the user A clicks an “Execute Review” button displayed on the display 2a of the terminal 2, the comment generation unit 22 of the server apparatus 1 may analyze each contract document and may generate comments as a comment generation process. For the comments generated by the comment generation process, the comment modification unit 24 may modify the comments in consideration of the contract document to be preferentially applied, which has been set at step S3, as a comment modification process. If only one contract document file is uploaded at step S2, the contract document may be reviewed alone, and modification of comments may not be executed.

If the “Execute Review” button is clicked without a contract document to be preferentially applied being selected by the user A at step S2, the article-of-priority extraction unit 28 may select the article of priority from the document file of each of the uploaded contract documents, and a contract document to be prioritized may be automatically set based on the content of the extracted article of priority. When the contract document to be preferentially applied is automatically selected, the selected contract document may be displayed on the display 2a of the terminal 2. Further, such a configuration may be made that, in a case where a contract document to be preferentially applied cannot be automatically selected, such as a case where the article of priority is not included in any of the contract documents, a message of “Select a contract document because no contract document to be prioritized cannot be identified” is displayed on the display 2a of the terminal 2 to prompt the user A to select a contract document to be preferentially applied.

Next, at step S5 of FIG. 4, the server apparatus 1 may cause a review result obtained by execution of review to be displayed on the display 2a of the terminal 2 as a comment output process. That is, the comments generated by execution of review may be outputted to the display 2a by the comment output unit 32 together with the articles of the reviewed contract documents, and the process of the flowchart shown in FIG. 4 may end. As a modification, it can also be make a configuration in which the user A can edit, via the terminal 2, the document file of a contract document which has been reviewed and to which comments have been attached. By modifying the document file with reference to the comments and clicking the “Execute Review” button again, the user A can read comments on the modified contract document and easily complete the contract document.

Next, an example of a result of review of contract documents by the contract document review program 10 of the embodiment of the present embodiment will be described with reference to FIGS. 6 to 12.

Drawings illustrated in FIGS. 6 to 8 show an example of a display screen of a result of executing review for “Basic Worker Dispatch Contract Document” alone (a result of uploading only “Basic Worker Dispatch Contract Document” and clicking the “Execute Review” button). Drawings illustrated in FIGS. 9 to 12 show an example of a display screens of a result of reviewing “Basic Worker Dispatch Contract Document” and “Individual Worker Dispatch Contract Document” at the same time (a result of clicking the “Execute Review” button in the state shown in FIG. 5). FIGS. 6 to 12 show an example of a review result in a case where the user A is in a position of a dispatcher of a worker dispatch contract.

“Basic Worker Dispatch Contract Document” exemplified here includes the following articles: “Article 1 (Purpose)”, “Article 2 (Scope of application)”, “Article 3 (Individual agreement)”, “Article 4 (Dispatch fee)”, “Article 5 (Handling of money, use of automobiles, and other special work)”, “Article 6 (Use of machinery and others)”, “Article 7 (Conditions of employment)”, “Article 8 (Safety and health, etc.)”, “Article 9 (Person in charge and commander)”, “Article 10 (Replacement of dispatched workers)”, “Article 11 (Complaint handling)”, “Article 12 (Obligation to disseminate recruitment information)”, “Article 13 (Belongingness of intellectual property right)”, “Article 14 (Prohibition of employment)”, “Article 15 (Prohibition of dispatch of workers who left jobs)”, “Article 16 (Confidentiality)”, “Article 17 (Protection of personal information about dispatched workers, etc.)”, “Article 18 (Use of facilities, etc.)”, “Article 19 (Work-related disaster)”, “Article 20 (Compensation for damage)”, “Article 21 (Cancellation of contract)”, “Article 22 (Cancellation of individual contract midway)”, “Article 23 (Elimination of antisocial forces)”, “Article 24 (Validity period)”, “Article 25 (Matters to be discussed)”, and “Article 26 (Applicable law and competent court).”

As shown in FIGS. 6 to 12, when review of a contract document/contract documents is executed, articles of a reviewed contract document/contract documents may be displayed in a left field of the display 2a of the terminal 2, and comments on the articles displayed in the left field may be displayed in a comment field on the right side of the display 2a.

For example, as shown in FIG. 7, the following may be displayed in the left field of the display 2a as Article 5 of Basic Worker Dispatch Contract Document: “The Client shall not have dispatched workers handle cash, securities or other similar securities and valuables, or work in special work such as work involving the use of vehicles.” Then, at the same time as the article may be highlighted on the display 2a, an arrow may be drawn toward the right field on the display 2a. In the comment field on the right side pointed to by the tip of the arrow, a comment for the highlighted article may be displayed.

In the example shown in FIG. 7, for Article 5 (Handling of money, use of automobiles, and other special work) of Basic Contract Document, the following comment is displayed: “[MEDIUM] It is prohibited to have dispatched workers perform work that requires them to handle cash or use a motor vehicle. Revision Policy: Delete the relevant part.” That is, the document file of Basic Contract Document read by the contract document reading unit 20 may be analyzed by the comment generation unit 22 of the control unit 12, and comments on the articles of Basic Contract Document may be generated. The generated comments may be displayed on the display 2a of the terminal 2 by the comment output unit 32.

At the top of each comment, the importance of the comment may be shown in black brackets first. In the above example, “[MEDIUM]”, which indicates that the importance of the comment is medium, is displayed at the top, and then the content of the comment is displayed. As the content of the comment, whether the content of the article is advantageous or disadvantageous for the user A, what kind of disadvantage the user suffers if the article is maintained, and the like may be shown. Furthermore, at the end of the comment, how modification (including addition, change, and/or deletion) of the article should be performed to avoid the disadvantage for the user A may be exemplified. In the above example, it is recommended to delete the relevant part as a revision policy.

Similarly, for Article 6 (Use of machinery and others) of Basic Contract Document of FIG. 7, the following comment is displayed: “[MEDIUM] The Dispatchers and dispatched workers must be lent machinery and other equipment necessary for their work. Revision Policy: Delete the relevant part.” At the end of the comment, it is recommended to delete the relevant part as a revision policy in the example shown in FIG. 7.

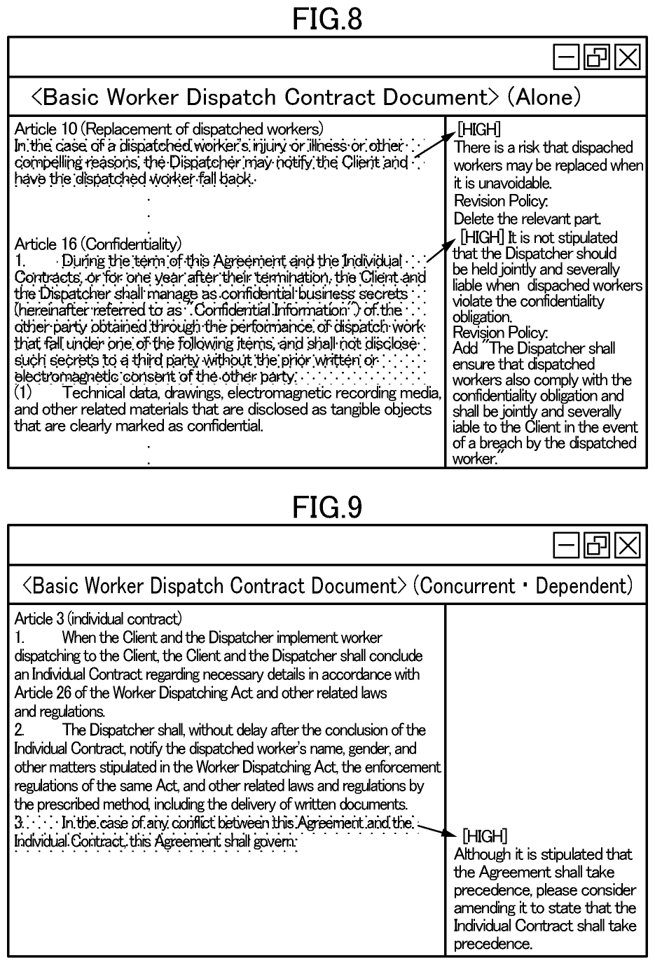

Furthermore, in the example shown in FIG. 8, to Article 10 (Replacement of dispatched workers) of Basic Contract Document, the following comment is attached: “[HIGH] There is a risk that dispatched workers may be replaced when it is unavoidable. Revision Policy: Delete the relevant part.”

Further, as shown in FIG. 8, to Article 16 (Confidentiality) of Basic Contract Document, the following comment is attached: “[HIGH] It is not stipulated that ‘the Dispatcher should be held jointly and severally liable when dispatched workers violate the confidentiality obligation’. Revision Policy: Add “The Dispatcher shall ensure that dispatched workers also comply with the confidentiality obligation and shall be jointly and severally liable to the Client in the event of a breach by the dispatched worker.”

As described above, the item acquisition unit 30 of the control unit 12 may acquire standard items that should be generally included in a worker dispatch contract type document, from the item database 38 stored in the auxiliary storage device 8. If an omitted item, which is an item included in the standard item but is not included in Basic Worker Dispatch Contract Document that is being reviewed is found, the comment generation unit 22 may generate an omission notification comment to notify the omission of the item. That is, in the above example, omission of an item to the effect that, when a dispatched worker violates the confidentiality obligation, the dispatcher should be held jointly and severally liable is found, and the following is notified as the omission notification comment: “It is not stipulated that ‘the Dispatcher should be held jointly and severally liable when dispatched workers violate the confidentiality obligation.’”

Furthermore, as shown in FIG. 6, for Article 4 (Dispatch Fee) of Basic Contract Document, the following section is stipulated: “1. The Client shall pay the dispatch fee to the Dispatcher as compensation for the worker. The dispatch fee shall be determined upon consultation between the Client and the Dispatcher, depending on the nature of the work, and others, for each individual Contract.” For this section, the following comments are generated by the comment generation unit 22: “[MEDIUM] The provision regarding late payment may be missing. Revision Policy: Add the provision into highlighted articles.” and “[HIGH] It is not stipulated whether the dispatch fee includes or excludes tax. It needs to be added. Revision Policy: Add distinction between tax inclusive and tax exclusive.” These comments may also be generated by comparing the standard items acquired from the item database 38 and Basic Worker Dispatch Contract Document that is being reviewed.

FIGS. 6 to 8 show a review result in the case of reviewing Basic Worker Dispatch Contract Document alone. In comparison, in the case of reviewing Basic Worker Dispatch Contract Document and Individual Worker Dispatch Contract Document at the same time (in the case of clicking the “Execute Review” button in the state shown in FIG. 5), the comments generated by the comment generation unit 22 may be modified by the comment modification unit 24. That is, the comment modification unit 24 may be configured to perform modification including addition, change and/or deletion for the comments on the first contract document generated by the comment generation unit 22, based on the content of the second contract document.

The drawings illustrated in FIGS. 9 to 12 show examples of display screens of a result of reviewing “Basic Worker Dispatch Contract Document” and “Individual Worker Dispatch Contract Document” at the same time (a result of clicking the “Execute Review” button in the state shown in FIG. 5). In the review result exemplified in FIGS. 9 to 12, modifications may be made for comments on Basic Worker Dispatch Contract Document, which is the first contract document, based on the content of Individual Worker Dispatch Contract Document, which is the second contract document.

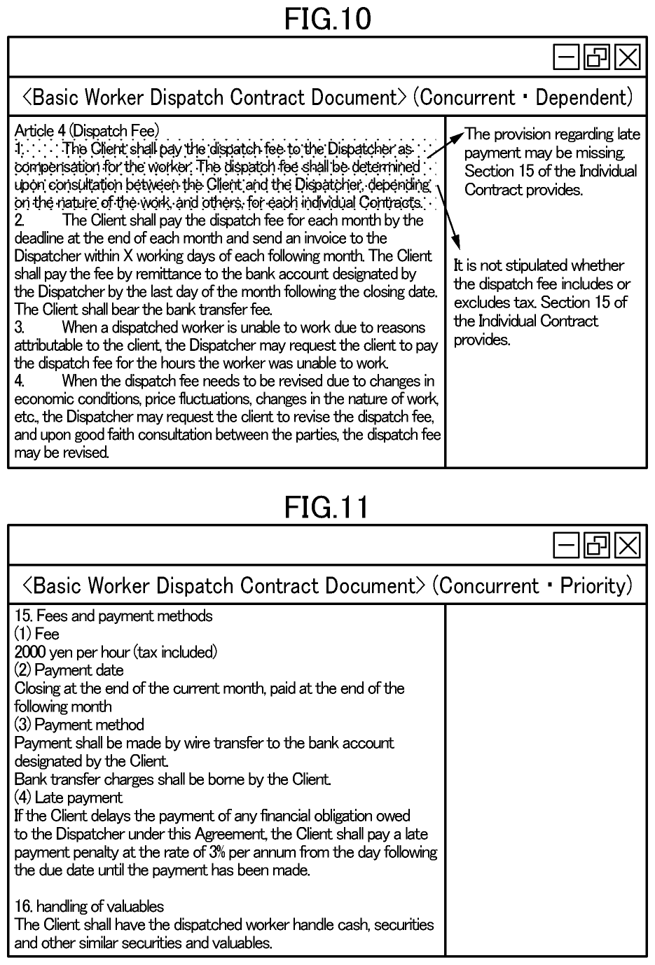

That is, as shown in FIG. 10, for Article 4 (Dispatch fee) of Basic Worker Dispatch Contract Document of this example, the following section, which is the same as that of Basic Worker Dispatch Contract Document shown in FIG. 6, is stipulated: “1. The Client shall pay the dispatch fee to the Dispatcher as compensation for the worker. The dispatch fee shall be determined upon consultation between the Client and the Dispatcher, depending on the nature of the work, and others, for each individual Contract.” In the example shown in FIG. 10, however, Section 15 of Individual Worker Dispatch Contract Document (FIG. 11) that is reviewed at the same time as Basic Worker Dispatch Contract Document stipulates the following: “(1) Fee: 2000 yen per hour (tax included)” and “(4) Late payment: If the Client delays the payment of any financial obligation owed to the Dispatcher under this Agreement, the Client shall pay a late payment penalty at the rate of 3% per annum from the day following the due date until the payment has been made.”

Therefore, in the example shown in FIG. 10, to Article 4 that is the same as the article shown in FIG. 6, the following comments are attached: “The provision regarding late payment may be missing. The Individual Contract provides.” and “It is not stipulated whether the dispatch fee includes or excludes tax. The Individual Contract provides.” That is, though the comment generation unit 22 may generate comments similar to those shown in FIG. 6, for Article 4 of Basic Worker Dispatch Contract Document, modifications for making changes as above are made for the comments by the comment modification unit 24 based on the content of Individual Worker Dispatch Contract Document. Or alternatively, the present embodiment may be configured so that, when the content of comments to be made for Basic Worker Dispatch Contract Document is indicated by the content of Individual Worker Dispatch Contract Document, the comments on Basic Worker Dispatch Contract Document are just deleted.

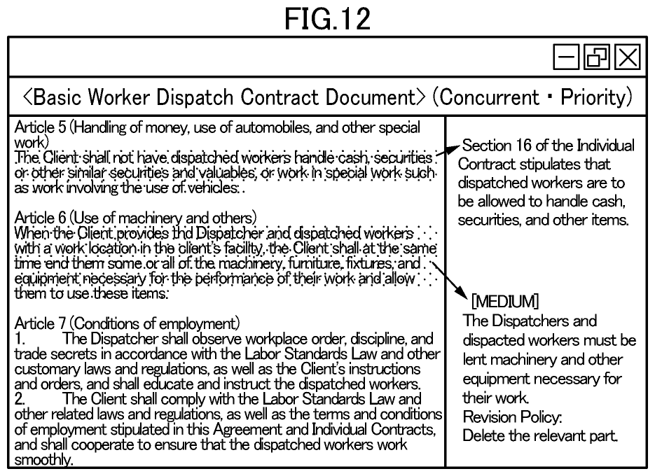

Furthermore, as shown in FIG. 12, as Article 5 (Handling of money, use of automobiles, and other special work) of Basic Worker Dispatch Contract Document, the following article, which is the same as that of Basic Worker Dispatch Contract Document shown in FIG. 7, is stipulated: “The Client shall not have dispatched workers handle cash, securities or other similar securities and valuables, or work in special work such as work involving the use of vehicles.” In the example shown in FIG. 12, however, Section 16 (Handling of valuables) of Individual Worker Dispatch Contract Document reviewed at the same time as Basic Worker Dispatch Contract Document stipulates the following: “The Client shall have the dispatched worker handle cash, securities and other similar securities and valuables.”

Therefore, in the example shown in FIG. 12, to Article 5 that is the same as the article shown in FIG. 7, the following comment is attached: “Section 16 of the Individual Contract stipulates that dispatched workers are to be allowed to handle cash, securities, and other items.” That is, though the comment generation unit 22 may generate comments similar to those shown in FIG. 7, for Article 5 of Basic Worker Dispatch Contract Document, modifications for making changes as above are made for the comments by the comment modification unit 24 based on the content of Individual Worker Dispatch Contract Document. Or alternatively, the present embodiment may be configured so that, since the matters to which attention should be paid with regard to Article 5 of Basic Worker Dispatch Contract Document are indicated by the content of Individual Worker Dispatch Contract Document, the comments on Article 5 of Basic Worker Dispatch Contract Document are not generated by the comment generation unit 22.

The modification of comments by the comment modification unit 24 described above is an example of a review result under a condition that Individual Worker Dispatch Contract Document is preferentially applied over Basic Worker Dispatch Contract Document as shown in FIG. 5. In comparison, when Basic Worker Dispatch Contract Document is set to be preferentially applied, by the preferential contract document setting unit 26, comments on Article 5 in FIG. 12 may be different comments. For example, when Basic Worker Dispatch Contract Document is preferentially applied, the following comment may be generated by the comment generation unit 22 on Article 5 of the Basic Worker Dispatch Contract Document: “Though Section 16 of the Individual Contract stipulates that dispatched workers are to be allowed to handle cash, securities, and other items, this Article is preferentially applied, and it is not possible to have a dispatched worker handle cash, securities and other similar securities.”

Thus, the comment generation unit 22 may generate comments based on a preferentially applied contract document set by the preferential contract document setting unit 26. Further, the comment modification unit 24 may modify the comments based on the preferentially applied contract document set by the preferential contract document setting unit 26. The present embodiment may also be configured so that, if there are stipulations that are duplicated or mutually conflict among a plurality of contract documents reviewed at the same time, comments may be attached only to articles of a contract document to be preferentially applied.

On the other hand, if a contract document to be prioritized is not set by the preferential contract document setting unit 26, a contract document to be preferentially applied may be set based on the article of priority extracted by the article of priority extraction unit 28. In this case, the comment generation unit 22 may generate comments based on the article of priority extracted by the article-of-priority extraction unit 28. Further, the comment modification unit 24 may modify the comments based on the article of priority extracted by the article-of-priority extraction unit 28.

In the example shown in FIG. 9, as the article of priority, Section 3 of Article 3 of Basic Worker Dispatch Contract Document stipulates the following: “3. In the case of any conflict between this Agreement and the Individual Contract, this Agreement shall govern.” In comparison, when an article that is advantageous for the position of the user A is stipulated in Individual Worker Dispatch Contract Document, the comment generation unit 22 may generate the following comment to recommend to change the contract document to be preferentially applied: “[HIGH] Although it is stipulated that the Agreement shall take precedence, please consider amending it to state that the Individual Contract shall take precedence.”

Furthermore, the present embodiment can also be configured so that, if an article of priority to the effect that Basic Worker Dispatch Contract Document is to be prioritized is extracted by the article-of-priority extraction unit 28 like the example shown in FIG. 9 even though it is set by the preferential contract document setting unit 26 that Individual Worker Dispatch Contract Document shall take precedence (FIG. 5), a comment that attention should be paid to this point may be generated. For example, the present embodiment may be configured to call attention of the user A by generating the following comment: “Though it is set that Individual Worker Dispatch Contract Document shall take precedence, an article to the effect that Basic Worker Dispatch Contract Document is to be prioritized is stipulated.”

As described above, in the example shown in FIGS. 9 to 12, comments on Basic Worker Dispatch Contract Document, which is the first contract document, are modified based on the content of Individual Worker Dispatch Contract Document, which is the second contract document to display the comments on the articles of Basic Worker Dispatch Contract Document. However, the present embodiment may be configured so that comments on Individual Worker Dispatch Contract Document are also displayed. In this case, the comments on Individual Worker Dispatch Contract Document, which is the first contract document, may be modified based on the content of Basic Worker Dispatch Contract Document, which is the second contract document, and the comments on the articles of Individual Worker Dispatch Contract Document may be displayed.

Furthermore, though the comment generation unit 22 and the comment modification unit 24 may be identified as separate functional units in the embodiment described above, these functional units may be integrated. In this case, comments generated by the comment generation unit 22 once may not be modified by the comment modification unit 24, but the comments for which addition, change, and/or deletion has been performed may be generated by the integrated functional unit.

Further, in the embodiment described above, the contract document review program 10 is installed in the server apparatus 1, and review of contract documents are performed by operating the contract document review program 10 via the terminal 2. However, the present embodiment can also be configured such that the contract document review program 10 is installed and used in a stand-alone computer. Or alternatively, the present embodiment can be configured as a contract document review apparatus by incorporating the contract document review program 10 into dedicated hardware.

According to an aspect of the present embodiment, since the comments on the first contract document generated by the comment generation unit 22 are modified by the comment modification unit 24 based on the content of the second contract document, it is possible to, even if there are a plurality of contract documents, review the contract documents with sufficient accuracy.

Further, according to an aspect of the present embodiment, since a contract document to be prioritized can be set by the preferential contract document setting unit 26, it may perform more appropriate generation of comments and/or modification of the comments.

Furthermore, according to an aspect of the present embodiment, since the article of priority is extracted by the article-of-priority extraction unit 28, and the content thereof is considered, it may perform more appropriate generation of comments and/or modification of the comments without missing the article of priority.

Further, according to an aspect of the present embodiment, since the item acquisition unit 30 acquires the standard items to be generally included in a predetermined contract, it may prevent omission of items required for a contract. Further, even if there is an item omitted from the first contract document, the omission notification comment may be deleted if the item is written in the second contract document. Therefore, it may appropriately review omission of an item from a contract that is completed by first and second contract documents.

Furthermore, according to an aspect of the present embodiment, since one of the first contract document and the second contract document is the basic contract document, and the other is the individual contract document, it may appropriately review the content of a contract by the basic contract document and the individual contract document that are in a mutually complementary relationship.

An embodiment of the present disclosure has been described above. Various changes, however, can be made for the embodiment described above. Especially, though the contract document review program of the present disclosure is used to review worker dispatch contract documents in the embodiment described above, the present embodiment can be applied to review of any contract document such as a sales contract document, a lease contract document, or an outsourcing contract document. Further, though a basic contract document and an individual contract document are reviewed by the contract document review program of the present invention at the same time in the embodiment described above, the present embodiment can be applied to review of a plurality of related contract documents, such as an original contract document and a changed contract document (including a change memorandum). In the present specification, a “contract document” means a legal document in which the content of agreement between concerned parties is written and does not limit the name of a document.

### REFERENCE SIGNS LIST

1 server apparatus (computer)
2 terminal
3 network
4 central processing unit
5 main storage device
6 input/output interface device
7 input device
8 auxiliary storage device
9 output device
10 contract document review program
12 control unit
18 user authentication unit
20 contract document reading unit
22 comment generation unit
24 comment modification unit
26 preferential contract document setting unit
28 article-of-priority extraction unit
30 item acquisition unit
32 comment output unit
34 user information
36 document files
38 item database
40 comment database

1.-7. (canceled)

8. A contract document review method for reviewing a contract document by a computer, the contract document review method comprising:
a contract document reading process for reading at least document files of a first contract document and a second contract document related to the first contract document, into a computer;
a comment generation process for generating comments on articles included in at least the first contract document, based on the document files read by the contract document reading process;
a comment modification process for performing modification including addition, change and/or deletion for the comments generated by the comment generation process, based on content of the second contract document; and
a comment output process for outputting the comments on the articles of the first contract document generated by the comment generation process and modified by the comment modification process.

9. The contract document review method according to claim 8, the method further comprising:
a preferential contract document setting process causing a user to set whether the articles included in the first contract document or articles included in the second contract document are to be preferentially applied, the first contract document and the second contract document having been read by the contract document reading process; and
wherein the comments are generated in the comment generation process based on the setting in the preferential contract document setting process, and/or the comments are modified in the comment modification process based on the setting in the preferential contract document setting process.

10. The contract document review method according to claim 9, further comprising:
an article-of-priority extraction process for extracting, from the document files of the first contract document and the second contract document, an article of priority stipulating the articles included in which of the first and second contract documents are to be prioritized; and
wherein in the comment generation process, the comments are generated based on content of the article of priority, and/or in the comment modification process the comments are modified based on the content of the article of priority.

11. The contract document review method according to claim 9, further comprising:
an item acquisition process for acquiring standard items from an item database storing items that are to be generally included in a predetermined contract; and
wherein in the comment generation process, if there is an omitted item, any item among the standard items that is not written in the first contract document, an omission notification comment to notify that there is an omitted item in the first contract document is generated; and
in the comment modification process, if the omitted item is written in the second contract document, the omission notification comment is modified.

12. The contract document review method according to claim 8,
wherein any one of the first contract document and the second contract document is a basic contract document, and the other of the first contract document and the second contract document is an individual contract document.

13. A contract document review apparatus reviewing a contract document, the contract document review apparatus comprising:
a contract document reading unit for reading at least document files of a first contract document and a second contract document related to the first contract document, into a computer;
a comment generation unit generating comments on articles included in at least the first contract document, based on the document files read by the contract document reading unit;
a comment modification unit performing modification including addition, change and/or deletion for the comments generated by the comment generation unit, based on content of the second contract document; and
a comment output unit outputting the comments on the articles of the first contract document generated by the comment generation unit and modified by the comment modification unit.

14. The contract document review apparatus according to claim 13 further comprising:
a preferential contract document setting unit causing a user to set whether the articles included in the first contract document or articles included in the second contract document are to be preferentially applied, the first contract document and the second contract document having been read by the contract document reading unit; and
wherein the comment generation unit generates the comments based on the setting by the preferential contract document setting unit, and/or the comment modification unit modifies the comments based on the setting by the preferential contract document setting unit.

15. The contract document review apparatus according to claim 14 further comprising:
an article-of-priority extraction unit extracting, from the document files of the first contract document and the second contract document, an article of priority stipulating the articles included in which of the first and second contract documents are to be prioritized; and
wherein the comment generation unit generates the comments based on content of the article of priority, and/or the comment modification unit modifies the comments based on the content of the article of priority.

16. The contract document review apparatus according to claim 14 further comprising:
an item acquisition unit acquiring standard items from an item database storing items that are to be generally included in a predetermined contract;
if there is an omitted item, any item among the standard items that is not written in the first contract document, the comment generation unit generates an omission notification comment to that effect; and
if the omitted item is written in the second contract document, the comment modification unit modifies the omission notification comment.

17. The contract document review apparatus according to claim 13, wherein any one of the first contract document and the second contract document is a basic contract document, and the other of the first contract document and the second contract document is an individual contract document.

18. A non-transitory computer-readable storage medium storing a contract document review program for causing a computer to review a contract document, the program causing the computer to function as:
a contract document reading unit for reading at least document files of a first contract document and a second contract document related to the first contract document, into a computer;
a comment generation unit generating comments on articles included in at least the first contract document, based on the document files read by the contract document reading unit;
a comment modification unit performing modification including addition, change and/or deletion for the comments generated by the comment generation unit, based on content of the second contract document; and
a comment output unit outputting the comments on the articles of the first contract document generated by the comment generation unit and modified by the comment modification unit.

19. The non-transitory computer-readable storage medium according to claim 18, wherein:
the program further causes the computer to function as a preferential contract document setting unit, the preferential contract document setting unit causing a user to set whether the articles included in the first contract document or articles included in the second contract document are to be preferentially applied, the first contract document and the second contract document having been read by the contract document reading unit; and
the comment generation unit generates the comments based on the setting by the preferential contract document setting unit, and/or the comment modification unit modifies the comments based on the setting by the preferential contract document setting unit.

20. The non-transitory computer-readable storage medium according to claim 19, wherein:
the program further causes the computer to function as an article-of-priority extraction unit, the article-of-priority extraction unit extracting, from the document files of the first contract document and the second contract document, an article of priority stipulating the articles included in which of the first and second contract documents are to be prioritized; and
the comment generation unit generates the comments based on content of the article of priority, and/or the comment modification unit modifies the comments based on the content of the article of priority.

21. The non-transitory computer-readable storage medium according to claim 19, wherein:
the program further causes the computer to function as an item acquisition unit, the item acquisition unit acquiring standard items from an item database storing items that are to be generally included in a predetermined contract;
if there is an omitted item, any item among the standard items that is not written in the first contract document, the comment generation unit generates an omission notification comment to that effect; and
if the omitted item is written in the second contract document, the comment modification unit modifies the omission notification comment.

22. The non-transitory computer-readable storage medium according to claim 18, wherein any one of the first contract document and the second contract document is a basic contract document, and the other of the first contract document and the second contract document is an individual contract document.
